(19) United States
(12) Patent Application Publication
(10) Pub. No.: US 2007/0218244 A1
(43) Pub. Date: Sep. 20, 2007

(54) Engineered handrail

(75) Inventor: Shu Wong Mak, Kowloon (HK)

Correspondence Address: SAND & SEBOLT, AEGIS TOWER, SUITE 1100, 4940 MUNSON STREET, NW, CANTON, OH, 44718-3615, US

(73) Assignee: Interwood International Limited, Kowloon (HK)

(21) Appl. No.: 11/511,761

(22) Filed: Aug. 29, 2006

Related U.S. Application Data
(63) Continuation-in-part of application No. 11/374,804, filed on Mar. 14, 2006.

(51) Int. Cl. B32B 5/00

(52) U.S. Cl. 428/98

(57) ABSTRACT

An elongated wood member such as a handrail comprising an elongated first and second layer of a lower grade wood product secured together to form an inner core; and an outer layer of a high grade wood product disposed substantially around all of said inner core except for a bottom surface thereof. The first and second layers are substantially vertically oriented relative to each other and have abutting side walls that may be planar in configuration or may be dovetailed to interlock together. The first, second and outer layers preferably are manufactured from the same wood product, that product preferably being solid timber strips or boards of oak or maple.

### CROSS-REFERENCE TO RELATED APPLICATIONS

This application is a continuation-in-part of U.S. patent application Ser. No. 11/374,804, filed Mar. 14, 2006, the entire specification of which is incorporated herein by reference.

### BACKGROUND OF THE INVENTION

1. Technical Field

This invention generally relates to railing systems. More particularly, the invention relates to an engineered handrail. Specifically, the invention relates to a handrail which includes an outer layer of a relatively high grade wood product which surrounds an inner core made from a plurality of layers of a lower grade wood of the same species as the outer layer.

2. Background Information

Handrails have been made from solid pieces of wood for many centuries. However, with the rising cost of wood, it has become customary to manufacture handrails with an inner core of an inexpensive or inferior wood and to cover this core with a veneer of a more expensive and superior wood. This gives the handrail the external appearance of being manufactured entirely of the superior wood, but reduces the production costs of the rail.

This type of process has been disclosed in the prior art in U.S. Pat. Nos. 6,367,878 and 6,582,021; both issued to Chung for an arm rail with an oak veneer layer. In these patents, Chung discloses a substantially solid inner core formed of an inferior wood that is surrounded by a very thin, shaped veneer layer in the U.S. Pat. No. 6,367,878 and by a thicker, three piece veneer layer in the U.S. Pat. No. 6,582,021. The construction disclosed by Chung in these patents works well for an arm rail because of its short length, the fact that it is almost never seen from below and that other components are typically not connected to the underside of the arm rail. This type of construction does not work as well if used to manufacture handrails. The first reason for this is that handrails are much longer than armrests. Over time a relatively thin, elongated piece of wood will tend to warp along its length giving the piece of wood a bowed appearance. This tendency is fairly minimal when high quality woods are used, but is more likely in inexpensive, lowergrades of woods. Consequently, manufacturing a relatively thin, elongated handrail and using an inexpensive, lower grade wood core, would increase the likelihood that the handrail will become bowed over time. Furthermore, lower grade woods tend to have more knots and holes and the fibers of the wood are less dense. These woods also crack more easily. Consequently a lower grade wood core would not provide a stable solid base into which other components, such as balusters, can be securely fixed. The underside of a handrail is also important because they are frequently seen from below, either from lower floors in a building or when climbing up a staircase. Using a dissimilar, inexpensive wood as the inner core to a handrail would therefore result in an unsightly underside to the handrail and would highlight the fact that the handrail is not made from a single piece of wood. Chung addressed this to a certain degree in U.S. Pat. No. 6,582,021, in FIG. 6, where he shows a thin veneer layer disposed over the interior core. While the veneer layer would hide the lower grade core, it would not prevent the tendency of the core to crack when components are connected to the underside of the handrail.

There is therefore a need in the art for an improved engineered handrail that will not warp and bow over time that aesthetically has the appearance of a solid piece of wood, but is stable and strong enough to securely affix components to the underside of the handrail.

### SUMMARY OF THE INVENTION

The device of the present invention comprises an elongated wood member, such as a handrail, comprising an elongated first and second layer of a lower grade wood product secured together to form an inner core; and an outer layer of a high grade wood product disposed substantially around all of said inner core, except for a bottom surface thereof. The first and second layers are substantially vertically oriented relative to each other and have abutting side walls that may be planar in configuration or may be dovetailed to interlock together. The first, second and outer layers preferably are manufactured from the same wood product, that product preferably being solid timber strips or boards of oak or maple.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a handrail in accordance with the present invention;

FIG. 2 is a cross-sectional end view of a first embodiment of the handrail of FIG. 1 and showing a first configuration of the layers of the inner core of the handrail;

FIG. 3 is a cross-sectional end view of the handrail of the present invention, showing a second configuration of the layers of the inner core of the handrail;

FIG. 4 is a cross-sectional end view of the handrail showing a third configuration of the layers of the inner core;

FIG. 5 is a cross-sectional end view of a second embodiment of a handrail in accordance with the present invention and showing a configuration of the layers of the inner core;

FIG. 6 is a cross-sectional end view of the second embodiment of the handrail and showing a second configuration of the layers of the inner core;

FIG. 7 is a cross-sectional end view of the second embodiment of the handrail and showing a third configuration of the layers of the inner core of the handrail;

FIG. 8 is a cross-sectional end view of the second embodiment of the handrail and showing a fourth configuration of the layers of the inner core;

FIG. 9 is a cross-sectional end view of the second embodiment of the handrail and showing a fifth configuration of the layers of the inner core; and

FIG. 10 is a cross-sectional end view of the second embodiment of the handrail and showing a sixth configuration of the layers of the inner core.

### DETAILED DESCRIPTION OF THE INVENTION

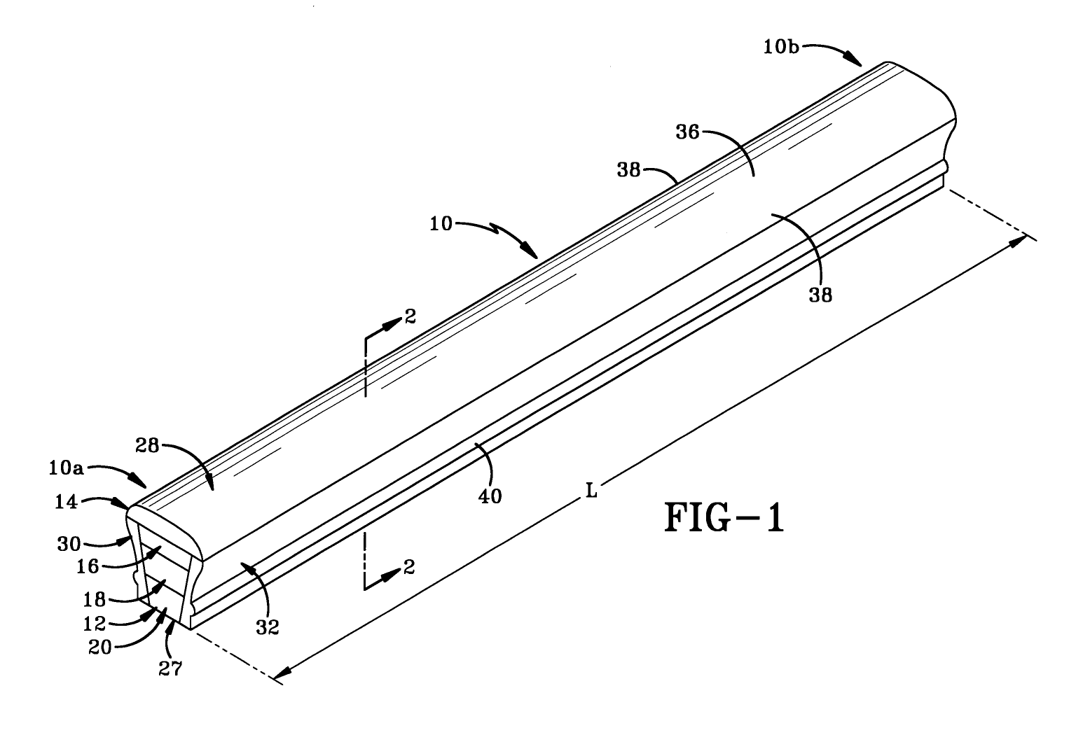

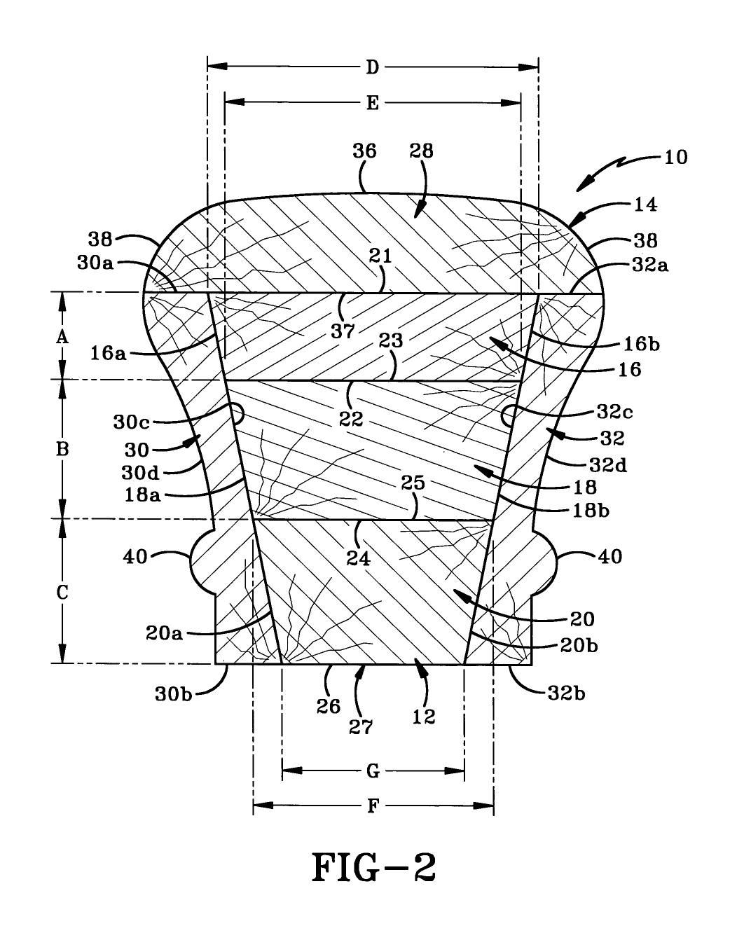

Referring to FIGS. 1 and 2, there is shown an elongated handrail in accordance with the present invention and generally indicated at 10. Handrail 10 comprises an inner core, generally indicated at 12, and an outer region, generally indicated at 14. Handrail 10 has a first end 10a and a second end 10b and has a length “L” therebetween. FIG. 1 shows handrail 10 with the inner construction thereof being exposed. It will be understood, however, that the layered inner core 12 and outer region 14 would not be seen in a handrail mounted for use on a wall because the ends 10a, 10b would be finished off as part of outer region 14.

In accordance with one of the specific features of the present invention, inner core 12 comprises a plurality of layers of wood bonded together. As shown in FIG. 2, inner core 12 comprises three layers 16, 18 and 20. Layers 16 and 18 comprise elongated solid timber or boards of relatively inexpensive and lower grade woods of the same species. Layer 20, on the other hand, comprises solid timber strips or boards of a more expensive and higher grade wood of the same species. The solid timber strips or boards in each of layers 16, 18, 20 are in multiple-lengths and finger-joined together to form the total length of the handrail, that being length “L”. The strips or boards in layers 16, 18, 20 preferably are of different thicknesses, namely “A”, “B” and “C” respectively. The actual thicknesses “A” and “B” of layers 16 and 18, respectively, can differ from rail to rail, but layer 20 needs to be of a thickness “C” sufficient to allow for balusters (not shown) or other components to be securely mounted therein or thereon. Layer 20 therefore preferably is between ¼ inch and 1 inch thick.

As seen from FIG. 2, the boards in layers 16, 18 and 20 preferably taper so as to produce an inner core 12 that is generally a truncated V-shape. Layer 16 has an upper surface 21 and a lower surface 22. The board of layer 16 has a maximum width “D” proximate upper surface 21 and a minimum width “E” proximate lower surface 22. The board of layer 18 has an upper surface 23 and a lower surface 24 and has a maximum width “E” proximate upper surface 23 and a minimum width “F” proximate lower surface 24. The board of layer 20 has an upper surface 25 and a lower surface 26 and has a maximum width “F” proximate the upper surface 25 and a minimum width “G” proximate lower surface 26. Lower surface 26 forms a substantial portion of the underside 27 of handrail 10.

In accordance with another specific feature of the present invention, layers 16, 18, 20 preferably are disposed horizontally one above another and an adhesive is applied between layers 16 and 18. An adhesive is also applied between layers 18 and 20. This results in an inner core 12 where upper surfaces 21, 23 and 25 of layers 16, 18 and 20 are disposed substantially parallel to the upper surface 36 of handrail 10. It will be understood that it would be possible to orient layers 16 and 18 vertically, i.e., so that they will ultimately lay substantially at right angles to the upper surface 36 of handrail 10. Layers 16 and 18 would be glued to each other and then the combined unit would be glued to a horizontally oriented layer 20. Utilizing horizontally oriented layers of wood results in a handrail that is both strong and has a reduced tendency to warp along the rail's length “L”. It would be undesirable to all three layers 16, 18 and 20 oriented vertically as the inferior materials and the joint lines would be visible on the underside of the handrail, the rail would have a greater tendency to warp along length “L” and the joints between layers 16, 18 and 18, 20 would form lines of weakness that would potentially cause problems when installing balusters and the like.

FIGS. 3-4 show different possible configurations of how a plurality of solid strips or boards of wood may be joined together to create any of the layers 16, 18 and 20 of inner core 12. It will be understood that any of the joints shown in these figures can be used in any of the layers 16, 18 and 20, and the production of these layers is not limited to the configurations shown herein. However, in order to increase the width of any of these layers 16, 18 and 20, strips or boards of wood preferably are edge-glued to each other. In order to increase the length of layers 16, 18 and 20, strips or boards preferably are finger-joined together.

The outer region 14 of handrail 10 preferably comprises three separate and shaped pieces of wood being an upper section 28 and two lateral sections 30 and 32. All three pieces 28, 30 and 32 are manufactured from aesthetically appealing solid timber strips or boards of the same type of wood such as oak, maple etc. In order to have timber of a sufficient length to create pieces 28, 30 and 32, solid strips or boards may be butt-joined to one another.

Upper section 28 of outer region 14 has an upper surface 36 a lower surface 37 and arcuate side walls 38. Lower surface 37 of upper section 28 is adhesively bonded to the horizontally oriented upper surface 21 of layer 16. Lateral sections 30 and 32 are oriented generally vertically with respect to lower surface 37 of upper section 28. Each lateral section 30, 32 has a first end 30a, 32a, a second end 30b, 32b, an interior surface 30c, 32c and an exterior surface 30d, 32d. Lateral sections 30, 32 are oriented so that first ends 30a, 32a abut a portion of the bottom surface 37 of upper section 28 and are adhesively secured thereto. Interior surfaces 30c, 32c of lateral sections 30, 32 abut the sides 16a, 18a, 20a and 16b, 18b, 20b, of layers 16, 18 and 20 respectively, and are adhesively bonded thereto. Upper section 28 and lateral sections 30, 32 are shaped to give handrail 10 a gently rounded appearance that is both aesthetically pleasing and easy to grip.

Lateral sections 30, 32 are shown to be formed with a decorative molding 40 thereon. Molding 40 runs from the first end 10a to the second end 10b of rail. While molding 40 is shown to be formed as part of lateral sections 30, 32, it may be formed in any other suitable manner such as by the insertion of a rib as shown in U.S. Pat. No. 6,367,878.

Handrail 10 is installed by securing first end 10a thereof to a suitable support, such as a post or mounting bracket extending outwardly from a wall (not shown) and securing second end 10b to a second suitable support. Balusters (not shown) may also be inserted between handrail 10 and a bottom rail or stair treads. Preferably, the posts, mounting brackets or balusters are connected to layer 20 of handrail 10. The orientation and substantial thickness of layer 20 makes for a more stable base for the installation of balusters and the like and reduces the tendency of the handrail to crack during installation of the same. Furthermore, because layer 20 is manufactured from more expensive and better quality woods and preferably is a substantially unitary piece of material that is color-matched to outer region 14, once installed, the entire handrail 10 has the appearance of being manufactured from a single solid piece of wood.

While the preferred embodiment of the handrail of the present invention has been disclosed as being manufactured entirely from wood from the same species, with the outer region comprising higher grades of that wood and the inner core comprising lower grades of the same species, it will be understood by those skilled in the art that the inner core may alternatively be manufactured from different, less expensive, lower grade woods including manufactured wood products such as chip board or particle board.

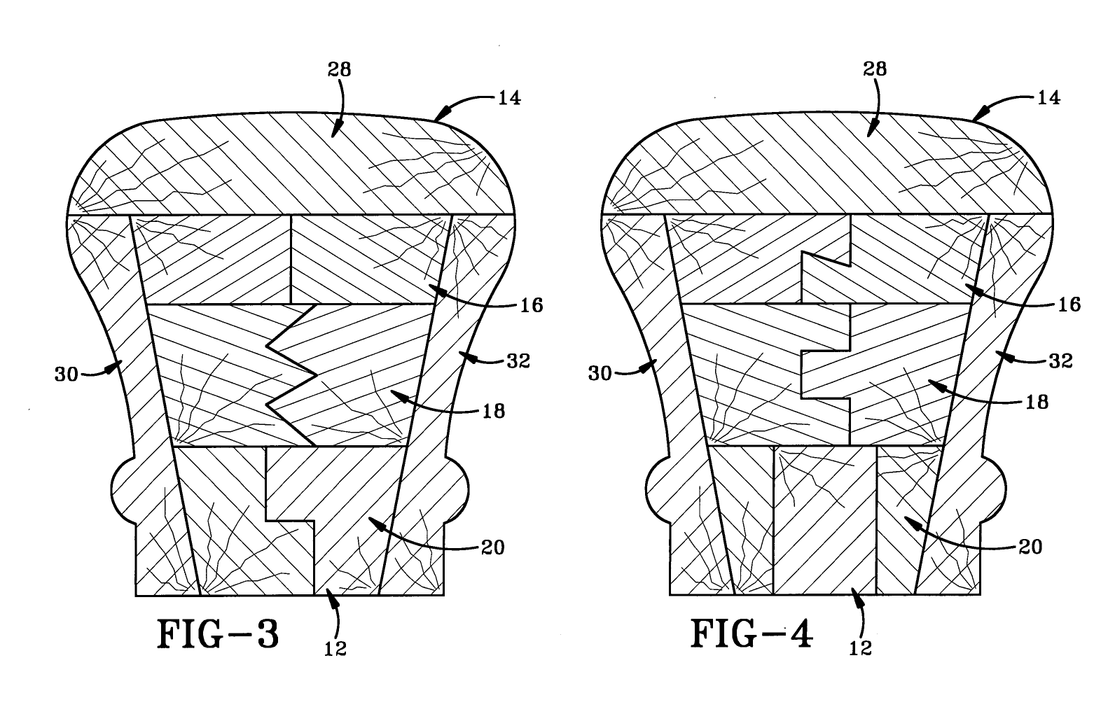

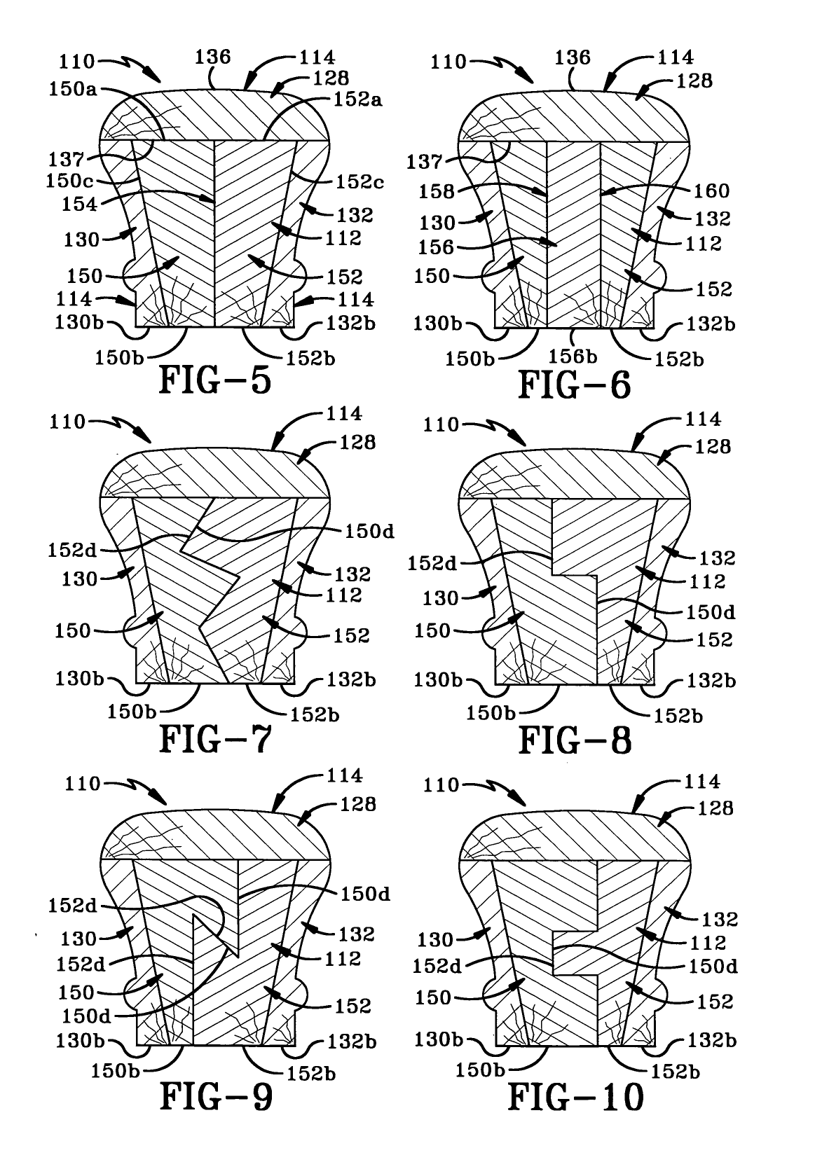

FIGS. 5-10 show a second embodiment of a handrail in accordance with the present invention and generally indicated at 110. Handrail 110 comprises an inner core, generally indicated at 112, and an outer region, generally indicated at 114. As with the handrail 10, outer region 114 of handrail 110 is made from relatively expensive, high grade woods and inner core 112 is made from relative inexpensive, lower grades of wood of the same species as outer region 114. Unlike handrail 10, handrail 110 does not include a bottom layer 20 that is made from the same grade of wood as outer region 114. Outer region 114 is constructed in essentially the same manner as outer region 14 of handrail 10.

FIG. 5 shows handrail 110 with a first configuration of layers 150, 152 comprising inner core 112. Layers 150, 152 are substantially identical in shape and taper from a wider portion 150a, 152a to a narrower portion 150b, 152b. Layers 150, 152 are oriented vertically and are adhesively connected to each other along a juncture 154. Juncture 154 is disposed substantially at right angles to the upper surface 136 of handrail 110. An adhesive is also applied between wider portions 150a, 152a and the interior surface 137 of upper portion 128 of outer region 114. Adhesive is also applied between sides 150c, 152c and lateral sections 130, 132 of outer region 114. The narrower portions 150b, 152b terminate substantially coplanar with the ends 130b, 132b of lateral sections 130, 132.

FIG. 6 shows a second configuration for the inner core 112 of handrail 110. In this configuration, a third layer 156, of lower grade, relatively inexpensive wood of the same species as outer region 114, is interposed between vertically oriented layers 150, 152. Layer 156 is substantially rectangular in cross-section and is adhesively attached to layers 150 and 152 as shown at junctures 158, 160. The lowermost portions 150b, 152b, 156b terminate substantially coplanar with ends 130b, 132b of lateral sections 130, 132.

FIG. 7 shows a third configuration for the inner core 112 of handrail 110 where layers 150, 152 are formed so that side walls 150d, 152d dovetail or interlock with each other. An adhesive is applied between side walls 150d, 152d to secure layers 150, 152 together. As with previous configurations, lowermost portions 150b, 152b terminate substantially coplanar with ends 130b, 132b.

FIGS. 8-10 show, respectively, fourth, fifth and sixth configurations of layers 150, 152 where portions of side walls 150d, 152d differ in shape, but interlock with and are adhesively secured to each other.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An elongated wood member comprising:
an elongated first layer of a lower grade wood product;
an elongated second layer of a lower grade wood product, said first and second layers abutting one another and being secured together along a juncture; said first and second layers defining an inner core; and wherein the inner core has an upper surface, a bottom surface and side surfaces;
an outer layer of a high grade wood product disposed substantially around all of said inner core except for the bottom surface thereof; said outer layer terminating in ends that are substantially coplanar with the bottom surface of the inner core.

2. The elongated wood member as defined in claim 1, wherein the first and second layers are manufactured from a lower grade wood product that is of the same species as the higher grade wood product of the outer layer.

3. The elongated wood member as defined in claim 2, wherein the outer layer is manufactured from substantially solid strips or boards of high grade wood and the first and second layers are manufactured from lower grade solid timber strips or boards of the same wood species.

4. The elongated wood member as defined in claim 1, wherein the first and second layers are substantially vertically oriented relative each other, whereby the juncture between the first and second layers is substantially vertical relative to an upper hand-engaging surface of the outer layer of the wood member.

5. The elongated wood member as defined in claim 1, wherein the first layer has an interior side wall and the second layer has an interior side wall and the interior side walls of the first and second layers are disposed in abutting contact with each other to form the juncture.

6. The elongated wood member as defined in claim 5, wherein the interior side walls of each of the first and second layers are substantially planar.

7. The elongated wood member as defined in claim 5, wherein the interior side wall of the first layer is complementary shaped to interlock with the interior side wall of the second layer.

8. The elongated wood member as defined in claim 1, further comprising at least a third layer of a lower grade wood product interposed between the first and second layers of the inner core.

9. The elongated wood member as defined in claim 1, further comprising an adhesive disposed between the upper surface of the inner core and an interior surface of the outer layer.

10. The elongated wood member as defined in claim 1, wherein each of the first and second layers tapers from a region of maximum width to a region minimum width.

11. The elongated wood member as defined in claim 10, wherein the regions of maximum width of the first and second layers form the upper surface of the inner core and the regions of minimum width form the bottom surface of the inner core.

12. The elongated wood member as defined in claim 11, further comprising an elongated third layer of a lower grade wood product that is disposed intermediate the first and second layers; and wherein the third layer is substantially rectangular in cross-section.

13. The elongated wood member as defined in claim 1, wherein the outer layer is comprised of an upper section and a pair of opposing lateral sections; the lateral sections extending downwardly away from said upper section so as to form a substantially U-shaped body.

14. The elongated wood member as defined in claim 13, wherein the elongated wood member has a longitudinal axis extending between a first end and a second end thereof; and wherein each lateral section includes an elongated rib oriented substantially parallel to the longitudinal axis of the wood member.

15. The elongated wood member as defined in claim 14, wherein the lateral sections each have a first and second end, said first end of each lateral section being adhesively bonded to an underside surface of said upper section and said second end of each lateral section being disposed a spaced distance away from the underside surface.

16. The elongated wood member as defined in claim 15, wherein the second ends of the lateral sections are substantially coplanar with the bottom surface of the inner core.

17. The elongated wood member as defined in claim 15, wherein the lateral sections of the outer layer each have an interior surface; and the interior surface of each of the lateral sections is adhesively bonded to a side surface of the inner core.
